(19) United States
(12) Patent Application Publication
(10) Pub. No.: US 2023/0018030 A1
(43) Pub. Date: Jan. 19, 2023

(54) ACOUSTIC ANALYSIS DEVICE, ACOUSTIC ANALYSIS METHOD, AND ACOUSTIC ANALYSIS PROGRAM

(71) Applicant: The University of Tokyo, Tokyo (JP)

(72) Inventors: Hiroshi Saruwatari, Tokyo (JP); Yuki Kubo, Tokyo (JP); Norihiro Takamune, Tokyo (JP); Daichi Kitamura, Tokyo (JP)

(21) Appl. No.: 17/782,546

(22) PCT Filed: Dec. 1, 2020
(86) PCT No.: PCT/JP2020/044629

§ 371 Date: Jun. 3, 2022

(30) Foreign Application Priority Data
Dec. 5, 2019 (JP) 2019-220584

(51) Int. Cl. G10L 21/0216; G10L 21/0272

(52) U.S. Cl. CPC G10L 21/0216; G10L 21/0272

(57) ABSTRACT

An acoustic analysis device and the like that can separate acoustic signals of a target sound source at a higher speed are provided. The acoustic analysis device includes: an acquiring unit configured to acquire acoustic signals; a first generating unit configured to generate acoustic signals of diffuse noise using a first model which includes a spatial correlation matrix related to frequency, a first parameter related to the frequency, and a second parameter related to the frequency and time; a second generating unit configured to generate acoustic signals emitted from a target sound source using a second model which includes a steering vector related to the frequency, and a third parameter related to the frequency and the time; and a determining unit configured to determine the first parameter, the second parameter and the third parameter so that the likelihood of the first parameter, the second parameter and the third parameter is maximized. The determining unit decomposes an inverse matrix of the matrix related to the frequency and the time into an inverse matrix of the matrix related to the frequency, and determines the first parameter, the second parameter and the third parameter so that the likelihood is maximized.

### CROSS REFERENCE TO RELATED APPLICATION

The present application is based on Japanese Patent Application No. 2019-220584 filed on Dec. 5, 2019, and the contents thereof are cited herein below.

### TECHNICAL FIELD

The present invention relates to an acoustic analysis device, an acoustic analysis method and an acoustic analysis program.

### BACKGROUND ART

“Blind Sound Source Separation”, which separates mixed acoustic signals emitted from a plurality of sound sources, measured by a plurality of microphones, into original signals without prior information on the sound sources and mixed system, has been researched. As blind sound source separation methods, the methods disclosed in Non-Patent Documents 1 and 2 are known.

The methods disclosed in Non-Patent Documents 1 and 2 are called “independent low-rank matrix analysis (ILRMA)”, and can separate signals stably with relatively high accuracy.

### CITATION LIST

### Non-Patent Document

Non-Patent Document 1: D. Kitamura, N. Ono, H. Sawada, H. Kameoka, and H. Saruwatari, “Determined blind source separation unifying independent vector analysis and nonnegative matrix factorization,” IEEE/ACM Trans. ASLP, vol. 24, no. 9, pp. 1626-1641, 2016.
Non-Patent Document 2: D. Kitamura, N. Ono, H. Sawada, H. Kameoka, and H. Saruwatari, “Determined blind source separation with independent low-rank matrix analysis,” in Audio Source Separation, S. Makino, Ed. Cham: Springer, 2018, pp. 125-155.

### SUMMARY OF INVENTION

### Technical Problem

In ILRMA, acoustic signals emitted from different directions can be separated. However, in a case where acoustic signals emitted from one target sound source and noise signals emitted from omni-directions are mixed, ILRMA can separate only the mixed signals of the acoustic signals from the target sound source and the noise signals from omni-directions, and cannot separate the acoustic signals from the target sound source alone.

With the foregoing in view, it is an object of the present invention to provide an acoustic analysis device, an acoustic analysis method and an acoustic analysis program that allow the separation of acoustic signals from a target sound source at a higher speed.

### Solution to Problem

An acoustic analysis device according to an aspect of the present invention includes: an acquiring unit configured to acquire acoustic signals measured by a plurality of microphones; a first calculating unit configured to calculate a separation matrix for separating the acoustic signals into estimated values of acoustic signals emitted from a plurality of sound sources; a first generating unit configured to generate acoustic signals of diffuse noise, using a first model, which is determined by the separation matrix, and includes a spatial correlation matrix related to frequency, a first parameter related to the frequency, and a second parameter related to the frequency and the time; a second generating unit configured to generate acoustic signals emitted from a target sound source, using a second model, which is determined by the separation matrix, and includes a steering vector related to the frequency, and a third parameter related to the frequency and the time; and a determining unit configured to determine the first parameter, the second parameter and the third parameter so that the likelihood of the first parameter, the second parameter and the third parameter is maximized. The determining unit decomposes an inverse matrix of the matrix related to the frequency and the time into an inverse matrix of the matrix related to the frequency, and determines the first parameter, the second parameter and the third parameter so that the likelihood is maximized.

According to this aspect, the inverse matrix of the matrix related to the frequency and the time is decomposed into the inverse matrix of the matrix related to the frequency, therefore the computational amount can be reduced and the acoustic signals of the target sound source can be separated at high speed.

An acoustic analysis method according to another aspect of the present invention is performed by a processor included in an acoustic analysis device, and includes steps of: acquiring acoustic signal measured by a plurality of microphones; calculating a separation matrix for separating the acoustic signals into estimated values of acoustic signals emitted from a plurality of sound sources; generating acoustic signals of diffuse noise using a first model, which is determined by the separation matrix, and includes a spatial correlation matrix related to frequency, a first parameter related to the frequency, and a second parameter related to the frequency and time; generating acoustic signals emitted from a target sound source using a second model, which is determined by the separation matrix, and includes a steering vector related to the frequency, and a third parameter related to the frequency and the time; and determining the first parameter, the second parameter and the third parameter so that the likelihood of the first parameter, the second parameter and the third parameter is maximized. An inverse matrix of the matrix related to the frequency and the time is decomposed into an inverse matrix of the matrix related to the frequency, and the first parameter, the second parameter and the third parameter are determined so that the likelihood is maximized.

According to this aspect, the inverse matrix of the matrix related to the frequency and the time is decomposed into the inverse matrix of the matrix related to the frequency, therefore the computational amount can be reduced and the acoustic signals of the target sound source can be separated at high speed.

An acoustic analysis program according to another aspect of the present invention causes a processor included with an acoustic analysis device to function as: an acquiring unit configured to acquire acoustic signals measured by a plurality of microphones; a first calculating unit configured to calculate a separation matrix for separating the acoustic signals into estimated values of acoustic signals emitted from a plurality of sound sources; a first generating unit configured to generate acoustic signals of diffuse noise, using a first model, which is determined by the separation matrix, and includes a spatial correlation matrix related to frequency, a first parameter related to the frequency, and a second parameter related to the frequency and the time; a second generating unit configured to generate acoustic signals emitted from a target sound source, using a second model, which is determined by the separation matrix, and includes a steering vector related to the frequency, and a third parameter related to the frequency and the time; and a determining unit configured to determine the first parameter, the second parameter and the third parameter so that the likelihood of the first parameter, the second parameter and the third parameter is maximized. The determining unit decomposes an inverse matrix of the matrix related to the frequency and the time into an inverse matrix of the matrix related to the frequency, and determines the first parameter, the second parameter and the third parameter so that the likelihood is maximized.

According to this aspect, the inverse matrix of the matrix related to the frequency and the time is decomposed into the inverse matrix of the matrix related to the frequency, therefore the computational amount can be reduced and the acoustic signals from the target sound source can be separated at high speed.

### Advantageous Effects of Invention

According to the present invention, an acoustic analysis device, an acoustic analysis method and an acoustic analysis program that allow separation of acoustic signals of a target sound source at a higher speed can be provided.

### BRIEF DESCRIPTION OF DRAWINGS

FIG. 1 is a diagram depicting functional blocks of an acoustic analysis device according to an embodiment of the present invention.

FIG. 2 is a diagram depicting a physical configuration of the acoustic analysis device according to the present embodiment.

FIG. 3 is a diagram depicting an overview of a separation matrix calculated by the acoustic analysis device according to the present embodiment.

FIG. 4 is a diagram depicting a configuration of an experiment to separate acoustic signals emitted from a target sound source using the acoustic analysis device according to the present embodiment.

FIG. 5 is a graph indicating a separation performance in a case where the acoustic signals emitted from the target sound source are separated using the acoustic analysis device according to the present embodiment.

FIG. 6 is a graph indicating a computational time in a case where the acoustic signals emitted from the target sound source are separated using the acoustic analysis device according to the present embodiment.

FIG. 7 is a flow chart of the acoustic separation processing that is executed by the acoustic analysis device according to the present embodiment.

### DESCRIPTION OF EMBODIMENTS

Embodiments of the present invention will be described with reference to the accompanying drawings. In each diagram, a composing element denoted by a same reference sign has a same or similar configuration.

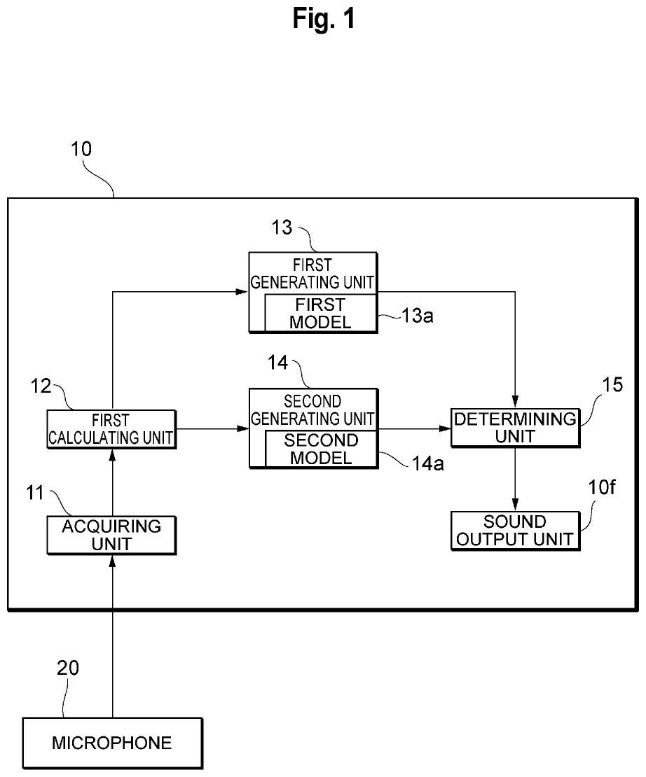

FIG. 1 is a diagram depicting functional blocks of the acoustic analysis device 10 according to an embodiment of the present invention. The acoustic analysis device 10 includes an acquiring unit 11, a first calculating unit 12, a first generating unit 13, a second generating unit 14 and a determining unit 15.

The acquiring unit 11 acquires acoustic signals measured by a plurality of microphones 20. The acquiring unit 11 may acquire acoustic signals, which were measured by the plurality of microphones 20 and stored in a storage unit, from the storage unit, or may acquire acoustic signals which are being measured by the plurality of microphones 20 in real-time.

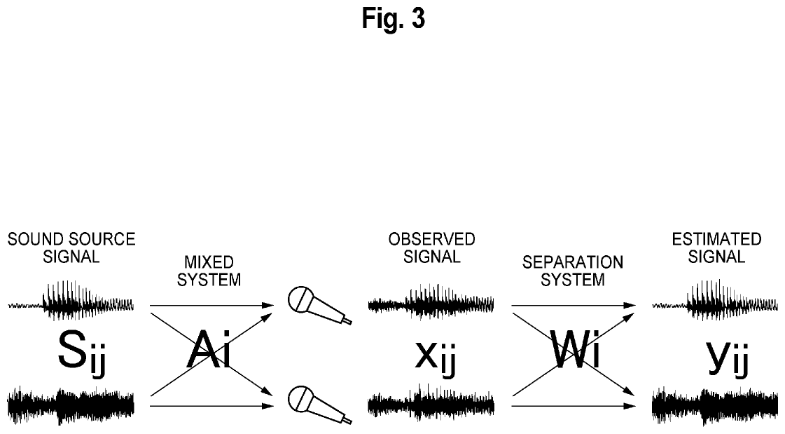

The first calculating unit 12 calculates a separation matrix to separate the acoustic signals into estimated values of acoustic signals emitted from a plurality of sound sources. The separation matrix will be described later with reference to FIG. 3.

The first generating unit 13 generates acoustic signals of diffuse noise using a first model 13a, which is determined by the separation matrix, and includes a spatial correlation matrix related to frequency, a first parameter related to the frequency and a second parameter related to the frequency and time. The processing to generate the acoustic signals of diffuse noise using the first model 13a will be described in detail later.

The second generating unit 14 generates acoustic signals emitted from a target sound source using a second model, which is determined by the separation matrix, and includes a steering vector related to the frequency and a third parameter related to the frequency and the time. The processing to generate the acoustic signals emitted from the target sound source using the second model 14a will be described in detail later.

The first generating unit 13 generates an acoustic signal uᵢⱼ of the diffusive noise, and the second generating unit 14 generates an acoustic signal hᵢⱼ emitted from the target sound source. The acoustic analysis device 10 determines the first parameter and the second parameter included in the first model 13a, and the third parameter included in the second model 14a, so that the relationship between the acoustic signal xᵢⱼ measured by the microphone 20 and the generated acoustic signal becomes xᵢⱼ=hᵢⱼ+uᵢⱼ.

The determining unit 15 determines the first parameter, the second parameter and the third parameter, so that the likelihood of the first parameter, the second parameter and the third parameter is maximized. Here the determining unit 15 decomposes the inverse matrix of the matrix related to the frequency and the time into the inverse matrix of the matrix related to the frequency, and determines the first parameter, the second parameter and the third parameter, so that the likelihood is maximized. The processing performed by the determining unit 15 will be described in detail later.

By decomposing the inverse matrix of the matrix related to the frequency and the time into the inverse matrix of the matrix related to the frequency, the computational amount can be reduced, and the acoustic signals from the target sound source can be separated at a higher speed.

The determining unit 15 also decomposes the inverse matrix of the matrix related to the frequency into the pseudo-inverse matrix of the matrix related to the frequency, and determines the first parameter, the second parameter and the third parameter, so that the likelihood is maximized. By decomposing the inverse matrix of the matrix related to the frequency into the pseudo-inverse matrix of the matrix related to the frequency, the computational amount can be further reduced, and the acoustic signals from the target sound source can be separated at an even higher speed.

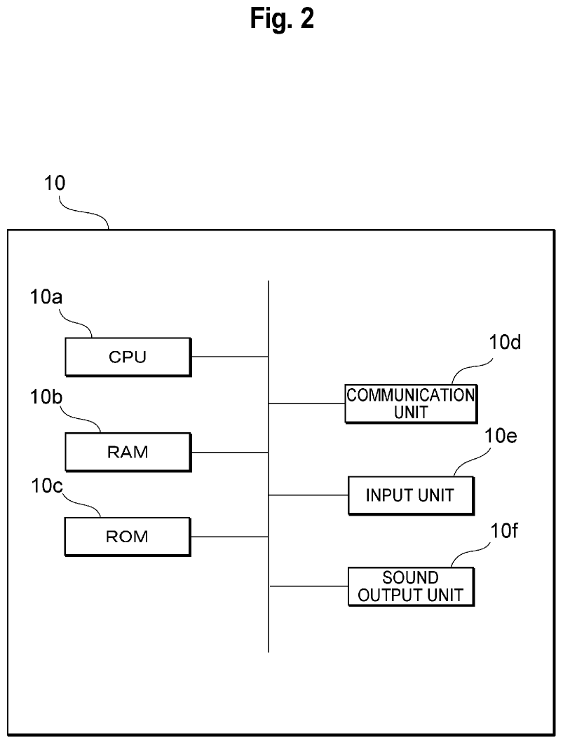

FIG. 2 is a diagram depicting a physical configuration of the acoustic analysis device 10 according to the present embodiment. The acoustic analysis device 10 includes a central processing unit (CPU) 10a which corresponds to an arithmetic unit, a random access memory (RAM) 10b which corresponds to a storage unit, a read only memory (ROM) 10c which corresponds to a storage unit, a communication unit 10d, an input unit 10e and a sound output unit 10f. Each of these composing elements is interconnected via a bus, so that data can be mutually transmitted/received. In this example, a case where the acoustic analysis device 10 is constituted of one computer will be described, but the acoustic analysis device 10 may be implemented by a combination of a plurality of computers. The configuration indicated in FIG. 2 is an example, and the acoustic analysis device 10 may have other composing elements, or may not have a part of these composing elements.

The CPU 10a is a control unit that controls the execution of programs stored in the RAM 10b or the ROM 10c, and computes and processes data. The CPU 10a is also an arithmetic unit that executes a program to separate acoustic signals from a target sound source (acoustic analysis program) from acoustic signals measured by a plurality of microphones. Furthermore, the CPU 10a receives various data from the input unit 10e and the communication unit 10d, and outputs the computational result of the data via the sound output unit 10f, or stores the result to the RAM 10b.

The RAM 10b is a storage unit in which data is overwritten, and may be constituted of a semiconductor storage element, for example. The RAM 10b may store programs executed by the CPU 10a and such data as acoustic signals. This is merely an example, and the RAM 10b may store other data, or may not store a part of these data.

The ROM 10c is a storage unit in which data is readable, and may be constituted of a semiconductor storage element, for example. The ROM 10c may store acoustic analysis programs and data that will not be overwritten, for example.

The communication unit 10d is an interface to connect the acoustic analysis device 10 to other apparatuses. The communication unit 10d may be connected to a communication network, such as the Internet.

The input unit 10e is for receiving data inputted by the user, and may include a keyboard or a touch panel, for example.

The sound output unit 10f is for outputting a sound analysis result acquired by computation by the CPU 10a, and may be constituted of a speaker, for example. The sound output unit 10f may output acoustic signals from a target sound source, which are separated from the acoustic signals measured by a plurality of microphones. Further, the sound output unit 10f may output acoustic signals to other computers.

The sound analysis program may be stored in a computer-readable storage medium, such as RAM 10b or ROM 10c, or may be accessible via a communication network connected by the communication unit 10d. In the acoustic analysis device 10, the CPU 10a executes the acoustic analysis program, whereby various operations described with reference to FIG. 1 are implemented. These physical composing elements are examples, and may not be standalone elements. For example, the acoustic analysis device 10 may include large-scale integration (LSI), where the CPU 10a, the RAM 10b and the ROM 10c are integrated.

FIG. 3 is a diagram depicting an overview of a separation matrix calculated by the acoustic analysis device 10 according to the present embodiment. Acoustic signals (sound source signals) emitted from a plurality of sound sources are mixed by a mixing system which is determined in accordance with the peripheral environment and the positions of the microphones 20. In a case where i (i=1 to I) denotes the frequency, j (j=1 to J) denotes the time, sᵢⱼ denotes a complex time frequency component of the acoustic signals emitted from the plurality of sound sources in the N-dimensional vector, and xᵢⱼ denotes a complex time frequency component of the acoustic signals (observed signals) measured by the microphone 20 in the M-dimensional vector, xᵢⱼ=Aᵢsᵢⱼ is established. Here N is a number of sound source. Aᵢ=(a_{i, 1}, a_{i, 2}, . . . , a_{i, N}) is called a “mixed matrix”, and is a complex matrix of M×N. A_{i, n} is called a “steering vector”, and is a vector in the M dimension. Here M is a number of microphones 20.

In the case where xᵢⱼ is a given, the first calculating unit 12 estimates the separation matrix Wᵢ=Aᵢ⁻¹. Here the estimation signal is yᵢⱼ=Wᵢxᵢⱼ, and sᵢⱼ is reproduced using yᵢⱼ.

The first calculating unit 12 may calculate the separation matrix Wᵢ using ILRMA. ILRMA is based on the condition that M=N and Aᵢ is regular. The acoustic analysis device 10 according to the present embodiment is based on the assumption that M=M and Aᵢ is regular.

The first generating unit 13 generates the acoustic signal uᵢⱼ of the diffusive noise using a first model 13a expressed by the following formula (1), where R′ᵢ^{(u)} denotes the spatial correlation matrix of the rank M−1, bᵢ denotes an orthogonal complement vector of R′ᵢ^{(u)}, λᵢ denotes a first parameter, and rᵢⱼ^{(u)} denotes a second parameter.

$${u}_{ij} ∼ {𝒩}_{c} ( 0 , {r}_{ij}^{( u )} {R}_{i}^{( u )} ) \qquad ( 1 )$$

$${R}_{i}^{( u )} = {R}_{i}^{′ ( u )} + {λ}_{i} {b}_{i} {b}_{i}^{H}$$

$${R}_{i}^{′ ( u )} = \frac{1}{J} {\sum }_{j} {W}_{i}^{1} ( {\vert {w}_{i , 1}^{H} {x}_{ij} \vert}^{2} , … , {\vert {w}_{i , {n}_{h} - 1}^{H} {x}_{ij} \vert}^{2} , 0 , {\vert {w}_{i , {n}_{h} + 1}^{H} {x}_{ij} \vert}^{2} , … , {\vert {w}_{i , M}^{H} {x}_{ij} \vert}^{2} ) {( {W}_{i}^{- 1} )}^{H}$$

Further, the second generating unit 14 generates the acoustic signal hᵢⱼ emitted from the target sound source using a second model 14a expressed by the following formula (2), where aᵢ^{(h)} denotes a steering vector, rᵢⱼ^{(h)} denotes a third parameter, and Ig (α, β) denotes an inverse gamma distribution determined by the hyper-parameters α and β. Here the hyper-parameters α and β may be α=1.1 and β=10⁻¹⁶, for example.

hᵢⱼ=aᵢ^{(h)}sᵢⱼ^{(h)}

sᵢⱼ^{(h)}|rᵢⱼ^{(h)}˜ [symbol] (0,rᵢⱼ^{(h)})

rᵢⱼ^{(h)}˜ [symbol] (α,β) (2)

The determining unit 15 calculates sufficient statistic rᵢⱼ^{(h)} and Rᵢⱼ^{(u)} using the following formula (3), where λᵢ with the tilde denotes the first parameter before update, rᵢⱼ^{(u)} with the tilde denotes the second parameter before update, and rᵢⱼ^{(h)} with the tilde denotes the third parameter before update. The formula (3) corresponds to the E step in the case where the first parameter, the second parameter and the third parameter are calculated by the expectation-maximization (EM) method.

\tilde{R}ᵢ^{(u)}=Rᵢ′^{(u)}+\tilde{λ}ᵢbᵢbᵢ^{H}

\tilde{R}ᵢⱼ^{(x)}=\tilde{r}ᵢⱼ^{(h)}aᵢ^{(h)}(aᵢ^{(h)})^{H}+\tilde{r}ᵢⱼ^{(u)}\tilde{R}ᵢ^{(u)}

\hat{r}ᵢⱼ^{(h)}=\tilde{r}ᵢⱼ^{(h)}−(\tilde{r}ᵢⱼ^{(h)})²(aᵢ^{(h)})^{H}(\tilde{R}ᵢⱼ^{(x)})⁻¹aᵢ^{(h)}+|\tilde{r}ᵢⱼ^{(h)}xᵢⱼ^{H}(\tilde{R}ᵢⱼ^{(x)})⁻¹aᵢ^{(h)}|²

\hat{R}ᵢⱼ^{(u)}=\tilde{r}ᵢⱼ^{(u)}\tilde{R}ᵢ^{(u)}−(\tilde{r}ᵢⱼ^{(u)})²\tilde{R}ᵢ^{(u)}(\tilde{R}ᵢⱼ^{(x)})⁻¹\tilde{R}ᵢ^{(u)}+(\tilde{r}ᵢⱼ^{(u)})²\tilde{R}ᵢ^{(u)}(\tilde{R}ᵢⱼ^{(x)})⁻¹xᵢⱼxᵢⱼ^{H}(\tilde{R}ᵢⱼ^{(x)})⁻¹\tilde{R}ᵢ^{(u)} (3)

Then the determining unit 15 updates the first parameter A the second parameter rᵢⱼ^{(u)} and the third parameter rᵢⱼ^{(h)} using the following formula (4). The formula (4) corresponds to the M step in the case where the first parameter, the second parameter and the third parameter are calculated by the EM method.

$${r}_{ij}^{( h )} ← \frac{{\hat{r}}_{ij}^{( h )} + β}{α + 2} \qquad ( 4 )$$

$${λ}_{i} ← \frac{1}{J} {\sum }_{j} \frac{1}{{\tilde{r}}_{ij}^{( u )}} {b}_{i}^{H} {\hat{R}}_{ij}^{( u )} {b}_{i}$$

$${R}_{i}^{( u )} ← {R}_{i}^{′ ( u )} + {λ}_{i} {b}_{i} {b}_{i}^{H}$$

$${r}_{ij}^{( u )} ← \frac{1}{M} tr ( {( {R}_{i}^{( u )} )}^{- 1} {\hat{R}}_{ij}^{( u )} )$$

Here in the case of the update, the determining unit 15 decomposes the inverse matrix of the matrix Rᵢⱼ^{(x)} related to the frequency and the time into the inverse matrix of the matrix Rᵢ^{(u)} related to the frequency using the following formula (5).

$${( {\tilde{R}}_{ij}^{( x )} )}^{- 1} = \frac{1}{{\tilde{r}}_{ij}^{( u )}} ( {( {\tilde{R}}_{i}^{( u )} )}^{- 1} - \frac{{\tilde{r}}_{ij}^{( h )}}{{\tilde{r}}_{ij}^{( u )} + {{\tilde{r}}_{ij}^{( h )} ( {a}_{i}^{( h )} )}^{H} {( {\tilde{R}}_{i}^{( u )} )}^{- 1} {a}_{i}^{( h )}} \cdot {( {\tilde{R}}_{i}^{( u )} )}^{- 1} {{a}_{i}^{( h )} ( {a}_{i}^{( h )} )}^{H} {( {\tilde{R}}_{i}^{( u )} )}^{- 1} ) \qquad ( 5 )$$

Rᵢⱼ^{(x)} has a component related to the time j, but the right hand side of formula (5) includes only the inverse matrix of Rᵢ^{(u)}, and does not include a component related to the time j. Thereby the computational amount can be reduced from O(IJM³) to O(IM³+IJM²).

In the case of the update, the determining unit 15 decomposes the inverse matrix of the matrix Rᵢ^{(u)} related to the frequency into a pseudo-inverse matrix (R′ᵢ^{(u)})⁺ of the matrix related to the frequency using the following formula (6).

$${( {\tilde{R}}_{i}^{( u )} )}^{- 1} = {( {R}_{i}^{′ ( u )} )}^{+} + \frac{1}{{\tilde{λ}}_{i}} {b}_{i} {b}_{i}^{H} \qquad ( 6 )$$

Here R′ᵢ^{(u)} is a quantity that does not depend on the first parameter A the second parameter rᵢⱼ^{(u)} and the third parameter rᵢⱼ^{(h)}, and is a quantity that is determined by calculating the spatial correlation matrix Wᵢ by ILRMA. The orthogonal compliment vector bᵢ of R′ᵢ^{(u)} is also a quantity determined by ILRMA. Therefore the formula (6) can be computed at high speed by using the initially calculated quantity determined by ILRMA. Thereby the computational amount is reduced to O(IJ).

In the present embodiment, the normal distribution is used for the first model 13a and the second model 14a, but a multivariate complex generalized Gaussian distribution, for example, may be used for a model to generate the acoustic signal xᵢⱼ measured by the microphone 20. Further, in the present embodiment, the EM method is used for the algorithm to maximize the likelihood of the parameters, but the majorization-equalization (ME) method or the majorization-minimization (MM) method may be used.

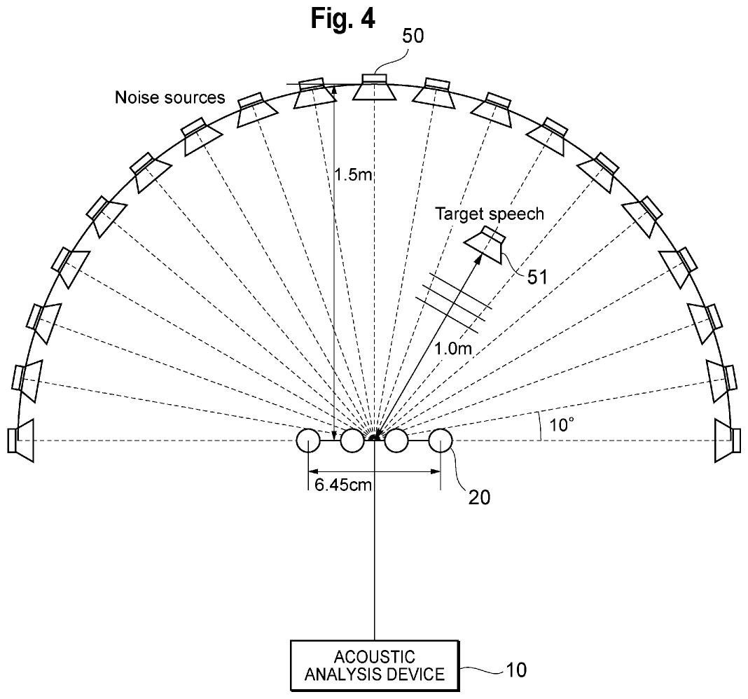

FIG. 4 is a diagram depicting a configuration of an experiment to separate acoustic signals emitted from a target sound source using the acoustic analysis device 10 according to the present embodiment. In this experiment, a plurality of speakers 50, which generate noise signals, are disposed at 10° intervals on a 1.5 m radius circumference with the microphone 20 at the center, and a speaker 51, which generates an acoustic signal from the target sound source, is disposed in a predetermined azimuth at a 1.0 distance from the microphone 20. In this experiment, four microphones 20 are disposed in a 6.45 cm range at equal intervals. The target sound source of this experiment is the human voice, and noise is also the human voice. This experiment has the task of selectively listening to a specific human voice in a state where many are speaking, that is, a task of reproducing a “cocktail party effect”.

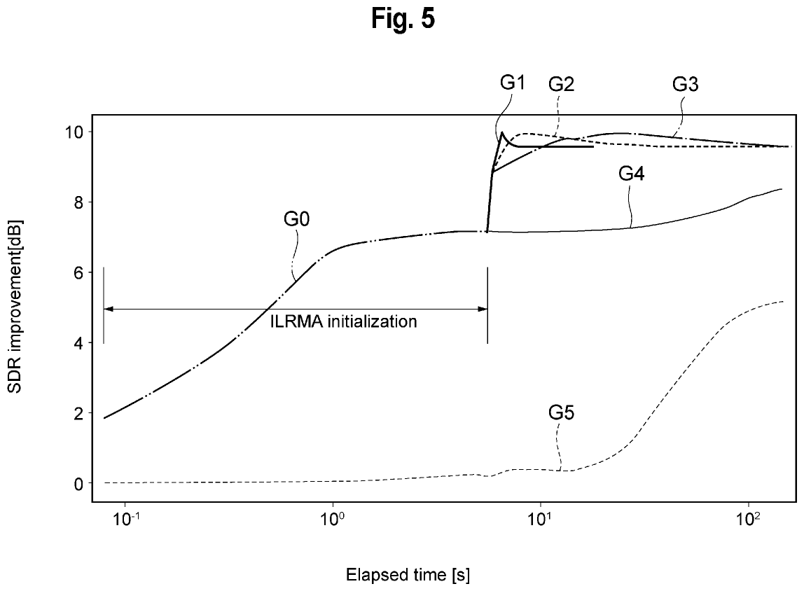

FIG. 5 is a graph indicating a separation performance in a case where the acoustic signals emitted from the target sound source are separated using the acoustic analysis device 10 according to the present embodiment. In FIG. 5, the source-to-distortion ratio (SDR) proposed by E. Vincent, R. Gribonval and C. Fevotte: “Performance measurement in blind audio source separation”, IEEE Trans. ASLP, Vol. 14, No. 4, pp. 1462-1469, 2006 is indicated in the ordinate as an evaluation index, and the elapsed time is indicated in the abscissa using a logarithmic scale. As indicated here, sound is better separated as the SDR increases.

FIG. 5 indicates a graph G0 in a case where ILRMA was used, a graph G1 in a case where the acoustic analysis device 10 according to the present embodiment was used, a graph G2 in a case where only decomposition of the inverse matrix was performed (decomposition of the pseudo-inverse matrix was not performed) in the acoustic analysis device 10 according to the present embodiment, and graph G3 in a case where neither decomposition of the inverse matrix nor decomposition of the pseudo-inverse matrix was performed in the acoustic analysis device 10 according to the present embodiment. FIG. 5 also indicates a graph G4 in a case where the method, called “FastMNMF”, proposed in K. Sekiguchi, A. A. Nugraha, Y. Bando and K. Yoshii: “Fast multichannel source separation based on jointly diagonalizable spatial covariance matrices,” CoRR, Vol. abs/1903.03237, 2019, and ILRMA were used, and a graph G5 in a case where only FastMNMF was used. The block indicated as “ILRMA initialization” indicates the execution time of the algorithm of ILRMA.

According to graph G1, the acoustic analysis device 10 according to the present embodiment achieves the highest SDR quicker than in other cases. The time to reach the highest value of SDR by the acoustic analysis device 10 according to the present embodiment is only slightly longer than the execution time of ILRMA, and the calculation based on the EM method of the first parameter, the second parameter and the third parameter quickly converges. The graph G2 and the graph G3 are cases where the decomposition of the pseudo-inverse matrix is not performed, or the decomposition of the inverse matrix and the decomposition of the pseudo-inverse matrix is not performed, hence calculation takes time, but an SDR equivalent to the acoustic analysis device 10 according to the present embodiment can be implemented.

The graph G4 and the graph G5 are cases of using FastMNMF, hence it takes a relatively long time for SDR to increase, and the highest value of SDR is lower than the case of the acoustic analysis device 10 of the present embodiment.

Therefore if the acoustic analysis device 10 according to the present embodiment is used, the target sound source can be separated at a faster speed and at higher precision than conventional methods.

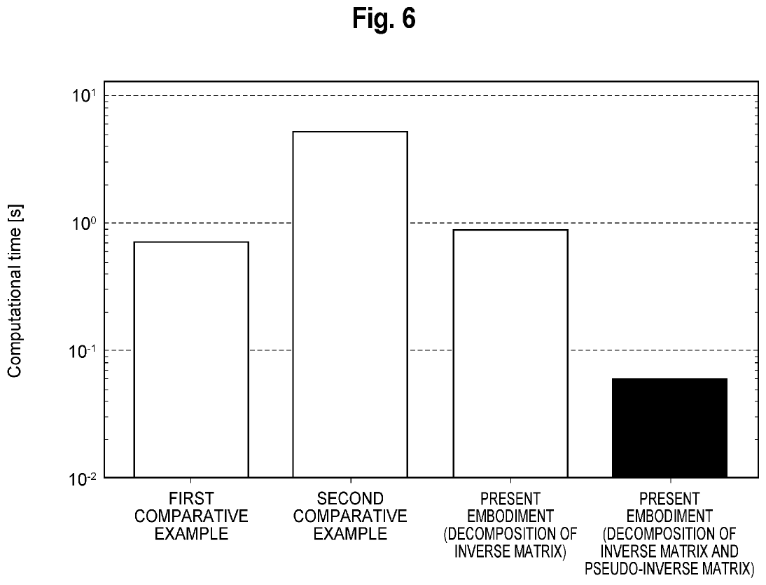

FIG. 6 is a graph indicating computational time in a case where the acoustic signals emitted from the target sound source are separated using the acoustic analysis device 10 according to the present embodiment. FIG. 6 indicates a computational time to separate acoustic signals emitted from each target sound source in the case of a first comparative example, a second comparative example, the present embodiment (decomposing inverse matrix), and the present embodiment (decomposing inverse matrix and pseudo-inverse matrix).

The first comparative example is the case of FastMNMF, and the computational time is about 0.7 seconds. The second comparative example is the case where neither decomposition of the inverse matrix nor decomposition of the pseudo-inverse matrix is performed in the acoustic analysis device 10 according to the present embodiment, and the computational time is about 5 seconds.

In the case where only decomposition of the inverse matrix is performed in the acoustic analysis device 10 according to the present embodiment, the computational time is about 0.8 seconds, and in the case where decomposition of the inverse matrix and decomposition of the pseudo-inverse matrix are performed in the acoustic analysis device 10 according to the present embodiment, the computational time is about 0.06 seconds.

In the acoustic analysis device 10 according to the present embodiment, the computational amount is O(IJM³) in the case where neither decomposition of the inverse matrix nor decomposition of the pseudo-inverse matrix is performed, the computational amount is O(IM³+IJM²) in the case where only decomposition of the inverse matrix is performed, and the computation amount is O(IJ) in the case where decomposition of the inverse matrix and decomposition of the pseudo-inverse matrix are performed. Thus according to the acoustic analysis device 10 of the present embodiment, the computational amount can be reduced to O(IJ) without depending on the number of sound sources (M=N), and the target sound source can be separated at higher speed than conventional methods. Specifically, the acoustic analysis device 10 of the present embodiment can separate the target sound source 12 times faster than FastMNMF, and the accuracy thereof is also higher than FastMNMF.

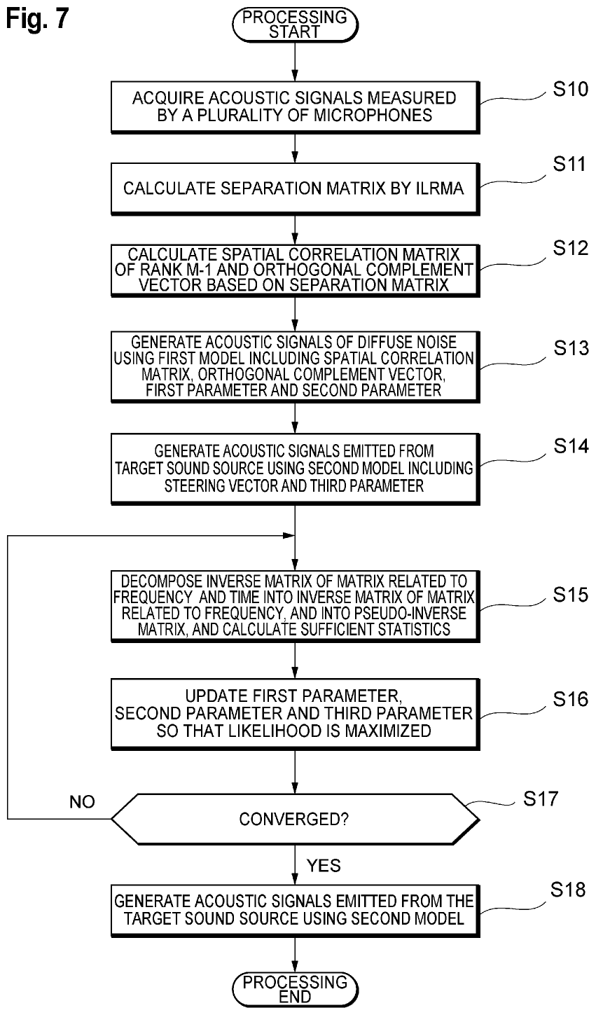

FIG. 7 is a flow chart of the acoustic separation processing that is executed by the acoustic analysis device 10 according to the present embodiment. First the acoustic analysis device 10 acquires acoustic signals measured by a plurality of microphones 20 (S10).

Then the acoustic analysis device 10 calculates the separation matrix by ILRMA (S11), and calculates the spatial correlation matrix and the orthogonal complement vector of rank M−1 based on the separation matrix (S12). Further, the acoustic analysis device 10 generates acoustic signals of diffuse noise using the first model including the spatial correlation matrix, the orthogonal complement vector, the first parameter and the second parameter (S13), and generates the acoustic signals emitted from the target sound source using the second model including the steering vector and the third parameter (S14).

Further, the acoustic analysis device 10 decomposes the inverse matrix of the matrix related to the frequency and the time into the inverse matrix of the matrix related to the frequency, and into the pseudo-inverse matrix, and calculates the sufficient statistic (S15). This processing corresponds to E step of the EM method.

Furthermore, the acoustic analysis device 10 updates the first parameter, the second parameter and the third parameter, so that the likelihood is maximized (S16). This processing corresponds to M step of the EM method.

In the case where the first parameter, the second parameter and the third parameter are not converged (S17: No), the acoustic analysis device 10 executes the processing S15 and the processing S16 again. The convergence may be determined depending on whether the difference of the likelihood values before and after updating the parameters is a predetermined value or less.

In the case where the first parameter, the second parameter and the third parameter are converged (S17: Yes), the acoustic analysis device 10 generates acoustic signals emitted from the target sound source using the second model (S18, and these acoustic signals become the final sound output.

The embodiments described above are to make understanding of the present invention easier, and are not intended to limit the interpretation of the present invention. Composing elements included in the embodiments, and dispositions, materials, conditions, shapes, sizes and the like of the composing elements are not limited to the examples described in the embodiments, but may be changed as necessary. Composing elements described in different embodiments may be partially replaced or combined.

### REFERENCE SIGNS LIST

10 Acoustic analysis device
10a CPU
10b RAM
10c ROM
10d Communication unit
10e Input unit
10f Sound output unit
11 Acquiring unit
12 First calculating unit
13 First generating unit
13a First model
14 Second generating unit
14a Second model
15 Determining unit
20 Microphone
50, 51 Speaker

1. An acoustic analysis device, comprising:
an acquiring unit configured to acquire acoustic signals measured by a plurality of microphones;
a first calculating unit configured to calculate a separation matrix for separating the acoustic signals into estimated values of acoustic signals emitted from a plurality of sound sources;
a first generating unit configured to generate acoustic signals of diffuse noise, using a first model, which is determined by the separation matrix, and includes a spatial correlation matrix related to frequency, a first parameter related to the frequency, and a second parameter related to the frequency and time;
a second generating unit configured to generate acoustic signals emitted from a target sound source, using a second model, which is determined by the separation matrix, and includes a steering vector related to the frequency, and a third parameter related to the frequency and the time; and
a determining unit configured to determine the first parameter, the second parameter and the third parameter so that the likelihood of the first parameter, the second parameter and the third parameter is maximized, wherein
the determining unit decomposes an inverse matrix of the matrix related to the frequency and the time into an inverse matrix of the matrix related to the frequency, and determines the first parameter, the second parameter and the third parameter so that the likelihood is maximized.

2. The acoustic analysis device according to claim 1, wherein
the determining unit decomposes an inverse matrix of the matrix related to the frequency into a pseudo-inverse matrix of the matrix related to the frequency, and determines the first parameter, the second parameter and the third parameter so that the likelihood is maximized.

3. The acoustic analysis device according to claim 1 or 2, wherein
the first generating unit generates an acoustic signal uᵢⱼ of the diffusive noise using the first model expressed by the following formula (1),
where i denotes the frequency, j denotes the time, xᵢⱼ denotes the acoustic signal, Wᵢ denotes the separation matrix, R′ᵢ^{(u)} denotes the spatial correlation matrix of a rank M−1, bᵢ denotes an orthogonal complement vector of the R′ᵢ^{(u)}, λᵢ denotes the first parameter, and rᵢⱼ^{(u)} denotes the second parameter.
$${u}_{ij} ∼ {𝒩}_{c} ( 0 , {r}_{ij}^{( u )} {R}_{i}^{( u )} ) \qquad ( 1 )$$
$${R}_{i}^{( u )} = {R}_{i}^{′ ( u )} + {λ}_{i} {b}_{i} {b}_{i}^{H}$$
$${R}_{i}^{′ ( u )} = \frac{1}{J} {\sum }_{j} {W}_{i}^{- 1} ( {\vert {w}_{i , 1}^{H} {x}_{ij} \vert}^{2} , … , {\vert {w}_{i , {n}_{h} - 1}^{H} {x}_{ij} \vert}^{2} , 0 , {\vert {w}_{i , {n}_{h} + 1}^{H} {x}_{ij} \vert}^{2} , … , {\vert {w}_{i , M}^{H} {x}_{ij} \vert}^{2} ) {( {W}_{i}^{- 1} )}^{H}$$

4. The acoustic analysis device according to any one of claims 1 to 3, wherein
the second generating unit generates an acoustic signal hᵢⱼ emitted from the target sound source using the second model expressed by the following formula (2),
where i denotes the frequency, j denotes the time, aᵢ^{(h)} denotes the steering vector, rᵢⱼ^{(h)} denotes the third parameter, and Ig (α, β) denotes an inverse gamma distribution determined by hyper-parameters α and β.
$${u}_{ij} ∼ {𝒩}_{c} ( 0 , {r}_{ij}^{( u )} {R}_{i}^{( u )} ) \qquad ( 2 )$$
$${R}_{i}^{( u )} = {R}_{i}^{′ ( u )} + {λ}_{i} {b}_{i} {b}_{i}^{H}$$
$${R}_{i}^{′ ( u )} = \frac{1}{J} {\sum }_{j} {W}_{i}^{- 1} ( {\vert {w}_{i , 1}^{H} {x}_{ij} \vert}^{2} , … , {\vert {w}_{i , {n}_{h} - 1}^{H} {x}_{ij} \vert}^{2} , 0 , {\vert {w}_{i , {n}_{h} + 1}^{H} {x}_{ij} \vert}^{2} , … , {\vert {w}_{i , M}^{H} {x}_{ij} \vert}^{2} ) {( {W}_{i}^{- 1} )}^{H}$$

5. The acoustic analysis device according to claim 3 or 4, wherein
the determining unit calculates sufficient statistics rᵢⱼ^{(h)} and Rᵢⱼ^{(u)} using the following formula (3),
where λᵢ with the tilde denotes the first parameter before update, rᵢⱼ^{(u)} with the tilde denotes the second parameter before update, and rᵢⱼ^{(h)} with the tilde denotes the third parameter before update,
\tilde{R}ᵢ^{(u)}=Rᵢ′^{(u)}+\tilde{λ}ᵢbᵢbᵢ^{H}
\tilde{R}ᵢⱼ^{(x)}=\tilde{r}ᵢⱼ^{(h)}aᵢ^{(h)}(aᵢ^{(h)})^{H}+\tilde{r}ᵢⱼ^{(u)}\tilde{R}ᵢ^{(u)}
\hat{r}ᵢⱼ^{(h)}=\tilde{r}ᵢⱼ^{(h)}−(\tilde{r}ᵢⱼ^{(h)})²(aᵢ^{(h)})^{H}(\tilde{R}ᵢⱼ^{(x)})⁻¹aᵢ^{(h)}+|\tilde{r}ᵢⱼ^{(h)}xᵢⱼ^{H}(\tilde{R}ᵢⱼ^{(x)})⁻¹aᵢ^{(h)}|²
\hat{R}ᵢⱼ^{(u)}=\tilde{r}ᵢⱼ^{(u)}\tilde{R}ᵢ^{(u)}−(\tilde{r}ᵢⱼ^{(u)})²\tilde{R}ᵢ^{(u)}(\tilde{R}ᵢⱼ^{(x)})⁻¹\tilde{R}ᵢ^{(u)}+(\tilde{r}ᵢⱼ^{(u)})²\tilde{R}ᵢ^{(u)}(\tilde{R}ᵢⱼ^{(x)})⁻¹xᵢⱼxᵢⱼ^{H}(\tilde{R}ᵢⱼ^{(x)})⁻¹\tilde{R}ᵢ^{(u)} (3)
the determining unit updates the first parameter λᵢ, the second parameter rᵢⱼ^{(u)} and the third parameter rᵢⱼ^{(h)} using the following formula (4),
$${r}_{ij}^{( h )} ← \frac{{\hat{r}}_{ij}^{( h )} + β}{α + 2} \qquad ( 4 )$$
$${λ}_{i} ← \frac{1}{J} {\sum }_{j} \frac{1}{{\tilde{r}}_{ij}^{( u )}} {b}_{i}^{H} {\hat{R}}_{ij}^{( u )} {b}_{i}$$
$${R}_{i}^{( u )} ← {R}_{i}^{′ ( u )} + {λ}_{i} {b}_{i} {b}_{i}^{H}$$
$${r}_{ij}^{( u )} ← \frac{1}{M} tr ( {( {R}_{i}^{( u )} )}^{- 1} {\hat{R}}_{ij}^{( u )} )$$
and
in the case of the update, the determining unit decomposes the inverse matrix of the matrix Rᵢⱼ^{(x)} related to the frequency and the time into the inverse matrix of the matrix Rᵢ^{(u)} related to the frequency using the following formula (5).
$${( {\tilde{R}}_{ij}^{( x )} )}^{- 1} = \frac{1}{{\tilde{r}}_{ij}^{( u )}} ( {( {\tilde{R}}_{i}^{( u )} )}^{- 1} - \frac{{\tilde{r}}_{ij}^{( h )}}{{\tilde{r}}_{ij}^{( u )} + {{\tilde{r}}_{ij}^{( h )} ( {a}_{i}^{( h )} )}^{H} {( {\tilde{R}}_{i}^{( u )} )}^{- 1} {a}_{i}^{( h )}} \cdot {( {\tilde{R}}_{i}^{( u )} )}^{- 1} {{a}_{i}^{( h )} ( {a}_{i}^{( h )} )}^{H} {( {\tilde{R}}_{i}^{( u )} )}^{- 1} ) \qquad ( 5 )$$

6. The acoustic analysis device according to claim 5, wherein
in the case of the update, the determining unit decomposes the inverse matrix of the matrix Rᵢ^{(u)} related to the frequency into a pseudo-inverse matrix (R′ᵢ^{(u)})⁺ of the matrix related to the frequency using the following formula (6).
$${( {\tilde{R}}_{i}^{( u )} )}^{- 1} = {( {R}_{i}^{′ ( u )} )}^{+} + \frac{1}{{\tilde{λ}}_{i}} {b}_{i} {b}_{i}^{H} \qquad ( 6 )$$

7. An acoustic analysis method performed by a processor included in an acoustic analysis device, the method comprising the steps of:
acquiring acoustic signals measured by a plurality of microphones;
calculating a separation matrix for separating the acoustic signals into estimated values of acoustic signals emitted from a plurality of sound sources;
generating acoustic signals of diffuse noise using a first model, which is determined by the separation matrix, and includes a spatial correlation matrix related to frequency, a first parameter related to the frequency, and a second parameter related to the frequency and time;
generating acoustic signals emitted from a target sound source using a second model, which is determined by the separation matrix, and includes a steering vector related to the frequency, and a third parameter related to the frequency and the time; and
determining the first parameter, the second parameter and the third parameter so that the likelihood of the first parameter, the second parameter and the third parameter is maximized, wherein
an inverse matrix of the matrix related to the frequency and the time is decomposed into an inverse matrix of the matrix related to the frequency, and the first parameter, the second parameter and the third parameter are determined so that the likelihood is maximized.

8. An acoustic program that causes a processor included in an acoustic analysis device to function as:
an acquiring unit configured to acquire acoustic signals measured by a plurality of microphones;
a first calculating unit configured to calculate a separation matrix for separating the acoustic signals into estimated values of acoustic signals emitted from a plurality of sound sources;
a first generating unit configured to generate acoustic signals of diffuse noise, using a first model, which is determined by the separation matrix, and includes a spatial correlation matrix related to frequency, a first parameter related to the frequency, and a second parameter related to the frequency and time;
a second generating unit configured to generate acoustic signals emitted from a target sound source, using a second model, which is determined by the separation matrix, and includes a steering vector related to the frequency, and a third parameter related to the frequency and the time; and
a determining unit configured to determine the first parameter, the second parameter and the third parameter so that the likelihood of the first parameter, the second parameter and the third parameter is maximized, wherein
the determining unit decomposes an inverse matrix of the matrix related to the frequency and the time into an inverse matrix of the matrix related to the frequency, and determines the first parameter, the second parameter and the third parameter so that the likelihood is maximized.
